(19) United States
(12) Patent Application Publication
(10) Pub. No.: US 2010/0263970 A1
(43) Pub. Date: Oct. 21, 2010

(54) BRAKE DISC AND METHOD FOR THE PRODUCTION THEROF

(75) Inventors: Siegfried Botsch, Grafenau (DE); Klaus Jaeckel, Nersingen (DE); Martin Lesch, Waiblingen (DE); Ilhan Oktay, Ebersbach (DE); Christian Quinger, Schorndorf (DE); Thomas Salewski, Winterbach (DE); David Wilke, Allmersbach im Tal (DE)

Correspondence Address: PATENT CENTRAL LLC;Stephan A. Pendorf, 1401 Hollywood Boulevard, Hollywood, FL, 33020, US

(73) Assignee: DAIMLER AG, Stuttgart (DE)

(21) Appl. No.: 12/808,202

(22) PCT Filed: Sep. 23, 2008
(86) PCT No.: PCT/EP08/08021

§ 371 Date: Jun. 15, 2010

(30) Foreign Application Priority Data
Dec. 21, 2007 (DE) 10 2007 061 954.7

(51) Int. Cl. F16D 65/12; B23K 31/02

(52) U.S. Cl. 188/218 XL; 228/176

(57) ABSTRACT

The invention relates to a brake disk for a motor vehicle having a brake disc cup (10) and having a friction ring (18) supported thereby and made of a cast material, joined to each other by means of a joint connection, particularly a welded connection (32), wherein an intermediate component (20) is cast into the friction ring (18), by means of which the friction ring (18) is connected to the brake disk cup (10). The invention further relates to a method for producing such a brake disk.

The invention relates to a brake disk for a motor vehicle and a method for the production thereof of the type set out in the preambles of claim 1 or 7.

From the state of the art are already known a plurality of brake disks or methods for their production, which are cast from a cast material in a single method step. These simple brake disks have however in particular the disadvantage of a high own weight. Due to this reason it has been usual for some time to use constructed brake disks, which essentially consist of a brake disk cup and a friction ring supported thereby. This has especially the advantage that the properties necessary at the different locations of the brake disk can be adjusted in a better manner. The brake disk cup, which usually consists of a steel material, can thus be designed in a corresponding sufficiently resilient manner, so that no wear and heat or tension tears result during the drive operation of the motor vehicle. The friction ring can however especially be constructed in such a manner that it has good wear-resistant properties.

A particular problem with brake disks constructed in this manner is however the connection of the brake disk cup to the friction ring. If for example a combination of a friction ring of a cast material, in particular a gray cast iron, and a brake disk cup of a steel material is chosen, a cement-like and brittle structure often results when welding the parts—depending on material pairing—on the side of the cast material, which is obviously detrimental for the stability of the brake disk.

Due to this reason, a brake disk and a method for its production is for example already known from DE 100 24 819 A1, in which a friction ring of gray cast material and a brake disk cup of an aluminum material are connected to each other by magnetic pulse welding or electromagnetic shaping in such a manner that a metallurgical connection results.

It is the object of the present invention to create a brake disk and a method for the production thereof of the type set out in the preambles of claim 1 or 7, in which an improved joint connection which is improved further, in particular a welded connection can be produced between the friction ring and the brake disk cup.

This object is solved according to the invention by a brake disk and a method for the production thereof with the characteristics of claim 1 or 7. Advantageous arrangements with convenient and non-trivial further developments of the invention are given in the further claims.

In order to achieve an improved joint connection, especially a welded connection, between the brake disk cup and the friction ring, it is provided according to the invention that an intermediate component is cast into the friction ring, by means of which the friction ring is connected to the brake disk cup. In other words, an intermediate component is cast into the friction ring in the connection region of the brake disk cup, whose material is adjusted to the material of the brake disk cup, in order to achieve an optimized joint connection, especially a welded connection in this manner.

As a result, a constructed brake disk can thereby be achieved, which is connected especially in the connection region between the brake disk cup and the friction ring in an optimized manner, in order to avoid, especially with high loads during the drive operation, a corresponding wear resistance or the development of tears or the like.

A particularly favorable connection between the friction ring and the brake disk cup can be achieved in that the intermediate component is formed as an intermediate ring arranged at the inner circumference of the brake disk.

A further favorable arrangement of the invention provides thereby that the intermediate component or the intermediate ring and the brake disk cup consist of a steel material. A welded connection can hereby be created between the brake disk cup and the intermediate ring, which has an optimized structure.

In a further arrangement of the invention, the intermediate component or the intermediate ring has a form-fit connection in the connection region to the cast material. Hereby, an optimum connection of the cast intermediate component or intermediate ring to the cast material of the friction ring is achieved.

It has further been shown to be advantageous if the intermediate component or the intermediate ring is provided with a layer, in particular a tin layer with preferably a layer thickness of about 1 to 30 μm. Such a layer, which is for example applied in a galvanic manner, enables in particular an especially good connection of the intermediate ring to the friction ring or the brake disk cup.

Due to the rotational symmetry, a friction welding is suitable in a further arrangement of the invention for joining the intermediate component and the brake disk cup. Alternatively to this, it is also conceivable in a further arrangement of the invention to use an inductive welding or press welding.

The advantages described above in connection with the brake disk according to the invention a valid in the same manner for the production method according to claim 7.

This is especially characterized in a further arrangement of the invention in that the friction ring with the intermediate component and the brake disk cup can at least essentially be finished prior to the production of the joint connection, especially the welded connection. The finishing of the individual components of the brake disk can be managed easier from experience than the assembly of brake disk cup and friction ring or intermediate component.

This previously described layer, in particular tin layer, is applied to the intermediate component or the intermediate ring prior to the casting into the friction ring. It can for example take place by galvanic spray coating prior to the casting into the friction ring which can be managed easily.

Further advantages, characteristics and details of the invention result from the following description of preferred embodiments and by means of the drawings; these show in:

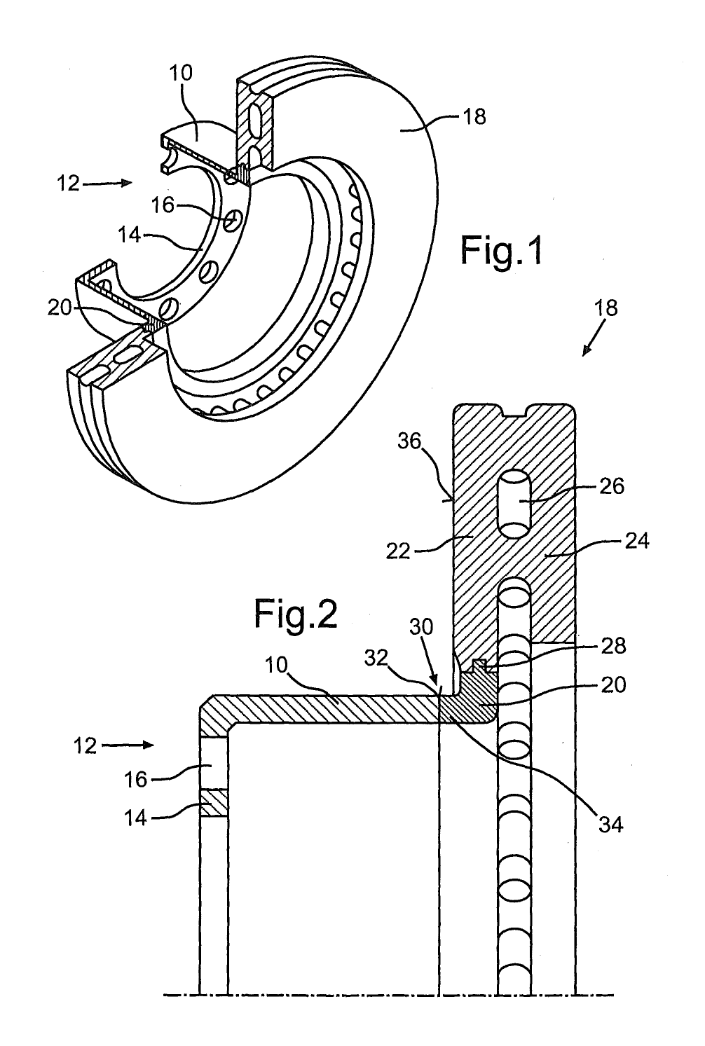

FIG. 1 a perspective of a brake disk for a motor vehicle, especially a utility vehicle, according to the invention, having a brake disk cup for fastening the brake disk to the wheel hub and for holding a friction ring consisting of a cast material, which is connected to the brake disk cup via a joint connection, especially a welded connection, wherein an intermediate component is cast into the friction ring, by means of which the friction ring is connected to the brake disk cup; and in

FIG. 2 a sectional view of the brake disk according to FIG. 1, wherein especially the intermediate component formed as an intermediate ring can be seen, which is cast into the friction ring and by means of which the friction ring is welded to the brake disk cup.

In FIG. 1 is shown a perspective in sections of a brake disk for a motor vehicle, in the present case a heavy goods vehicle. The brake disk comprises an essentially cylindrical brake disk cup 10, which is formed with an annular flange 14 at its one front face 12 for fastening a reception on the wheel hub side, not shown. The flange has a plurality of radially distributed through-holes 16 for this. The brake disk cup 10 presently consists of a steel material, which has correspondingly favorable ductile material and rigidity properties.

On the side facing away from the flange 14, the brake disk cup is connected to a friction ring 18 in a manner to be described in more detail, which presently consists of a cast material, for example gray cast material.

In connection with FIG. 2, which shows a sectional view of the brake disk in parts and axially according to FIG. 1, it can be seen that an intermediate component 20 in the form of an intermediate ring is provided in the connection region of the brake disk cup 10 at the friction ring 18. This intermediate component 20 or the intermediate ring has been cast to the inner circumference of the brake disk or the friction ring 18 during its casting process. More precisely, the intermediate component 20 has been cast into one of two friction ring bodies 22, 24 on the inner circumferential side, wherein the friction ring body 22 receiving the intermediate component 20 faces the brake disk cup 10. The two friction ring bodies 20, 22 are connected to each other in one piece via a plurality of intermediate bars 26, which ensure the interior ventilation of the friction ring 18.

The intermediate component 20 designed as an intermediate ring thereby has a bar 28 proceeding on the outer circumferential side as a means for producing a form-fit connection to the cast material of the friction ring 18. This bar especially ensures a particularly favorable connection of the intermediate component 20 especially in the axial direction of the friction ring 18 or of the brake disk.

The intermediate component 20 consists in the present case of a steel material, which is adjusted with its material properties in particular to those of the brake disk cup. It is hereby possible in a simple manner to provide a corresponding joint connection in the form of a welded connection 32 in a joint region 30 between the brake disk cup 10 and the intermediate component 20 on the friction ring side. A friction welding or an inductive welding is especially suitable as the welded connection in the present case.

It can especially additionally be seen from FIG. 2 that the intermediate component 20 in the form of the intermediate ring has a collar 34, which projects opposite a front face 36 of the friction ring 18 or of the associated friction ring body 22 towards the side of the brake disk cup. This enables a particularly favorable welded connection 32 between the brake disk cup 10 and the intermediate component 20.

The intermediate component 20 or the intermediate ring provided with a layer in the present case, especially a tin layer with a layer thickness of preferably about 1 to 30 μm, which is for example applied to the surface of the intermediate component 20 by galvanic spray coating. A particularly favorable connection to the friction ring 18 or to the brake disk cup 10 results hereby.

The production of the brake disk takes place in the following manner:

In the present case, the previously described layer, in particular the tin layer, is first applied to the intermediate component 20 or the intermediate ring by a corresponding galvanic spray coating or another coating method. Subsequently to this, the casting of the friction ring 18 and accompanying this the casting of the intermediate component 20 in the form of the intermediate ring into the friction ring 18 takes place.

Before the brake disk is assembled, the friction ring 18 with the intermediate component 20 on the one hand and the brake disk cup 10 on the other hand are at least essentially finished. This has in particular the advantage that the two individual parts of the assembly of the brake disk—the friction ring 18 with the intermediate component 20 on the one hand and the brake disk cup 10 on the other hand—can be processed in a particularly favorable and simple manner.

After this finishing, the joint process of the brake disk cup 10 with the intermediate component 20 then takes place, in order to hereby produce a welded connection between the friction ring 18 and the brake disk cup 10. This welded connection 32 can for example take place by means of friction welding or inductive welding in the present case. Other welding methods are of course also conceivable.

Altogether it can thus be seen from FIGS. 1 and 2, that a particularly favorable possibility is created that the friction ring 18 consisting of a cast material for example of a GG-15 or GG-20 material is created with a brake disk cup 10 consisting of a steel material, namely while interposing the intermediate component 20, which itself is cast into the cast material of the friction ring. The cast-in intermediate component 20 can thus be adapted to the material of the brake disk cup 10 in a particularly favorable manner, which presently can consist of a steel material with a corresponding higher tensile strength and an accompanying smaller dimensioning and smaller wall thicknesses. The weight of the respective brake disk can hereby be reduced considerably without resulting in losses of the connection of the brake disk cup 10 with the friction ring 18.

Altogether, a brake disk can be thus created which resists expansions and internal tensions resulting with the braking heat during a braking process.

It is thereby be seen to be included within the scope of the invention that of course other materials could be used instead of a steel material on the side of the brake disk cup 10 an on the side of the intermediate component 20, in particular aluminum alloys. In the present case, the casting of the intermediate component 20 into the friction ring 18 takes place by means of a composite casting method. Other methods would of course also be conceivable.

### LIST OF REFERENCE NUMERALS

10 Brake disk cup
12, 36 Front face
14 Flange
16 Through-hole
18 Friction ring
20 Intermediate component
22, 24 Friction ring body
26 Intermediate bars
28 Bar
30 Joint region
32 Wended connection
34 Collar

1-10. (canceled)

11. A brake disk for a motor vehicle comprising:
a brake disk cup (10) and
a friction ring (18) supported thereby, comprising a cast material,
wherein the brake disk cup and friction ring are joined to each other by means of a joint connection,
wherein an intermediate component (20) is cast into the friction ring (18), by means of which component the friction ring (18) is connected to the brake disk cup (10), wherein the intermediate component 20 has been cast into one of two friction ring bodies (22, 24) on the inner circumferential side,
wherein the friction ring body (22) receiving the intermediate component (20) faces the brake disk pot (10)
wherein the intermediate component (20) is in the form of an intermediate ring and has a collar (34), which projects, towards the brake disk cup, beyond a face (36) of the friction ring (18) or of the associated friction ring body (22), and
wherein the intermediate ring and the brake disk cup (10) are comprised of a steel material.

12. The brake disk according to claim 11, wherein the joint connection is a welded connection (32).

13. The brake disk according to claim 11, wherein the intermediate component (20) or the intermediate ring and the brake disk cup (10) consist of a steel material.

14. The brake disk according to claim 11, wherein the intermediate component (20) or the intermediate ring has a means (28) for producing a form-fit connection in the connection region to the cast material of the friction ring.

15. The brake disk according to claim 11, wherein the intermediate component (20) or the intermediate ring is provided with a layer.

16. The brake disk according to claim 15, wherein the layer is tin.

17. The brake disk according to claim 15, wherein the layer is tin and the layer thickness is about 1 to 30 μm.

18. The brake disk according to claim 11, wherein the intermediate component (20) or the intermediate ring is connected to the brake disk cup (10) by a friction welding or inductive welding.

19. A method for producing a brake disk for a motor vehicle, in which a brake disk cup (10) and a friction ring (18) supported thereby, the friction ring comprising a cast material, are connected to each other by a joint connection, in particular a welded connection (32), the method comprising the following steps:
casting an intermediate component (20) into the friction ring (18); and
producing the joint connection, between the intermediate component (20) of the friction ring (18) and the brake disk cup (10).

20. The method according to claim 19, wherein the joint connection is a welded connection (32).

21. The method according to claim 19, wherein the friction ring (18) with the intermediate component (20) and the brake disk cup (10) are finished at least essentially prior to the production of the joint connection.

22. The method according to claim 19, wherein the friction ring (18) with the intermediate component (20) and the brake disk cup (10) are finished at least essentially prior to the production of the joint connection, wherein the joint connection is a welded connection (32).

23. The method according to claim 19, wherein the intermediate component (20) is provided with a layer prior to the casting into the friction ring (18).

24. The method according to claim 19, wherein the intermediate component (20) is provided with a tin layer prior to the casting into the friction ring (18).

25. The method according to claim 19, wherein the intermediate component (20) is provided with a tin layer with a layer thickness of about 1 to 30 μm prior to the casting into the friction ring (18).

26. The method according to claim 19, wherein the tin layer, is applied by galvanic spray coating.
